(19) United States
(12) Patent Application Publication
(10) Pub. No.: US 2013/0008452 A1
(43) Pub. Date: Jan. 10, 2013

(54) Training and Rehabilitation Device

(76) Inventor: Steven Evangelos, Framingham, MA (US)

(21) Appl. No.: 13/536,402

(22) Filed: Jun. 28, 2012

Related U.S. Application Data
(60) Provisional application No. 61/503,297, filed on Jun. 30, 2011.

(51) Int. Cl. A61G 15/00

(52) U.S. Cl. 128/845

(57) ABSTRACT

A device includes a frame having a longitudinal support extending along a longitudinal axis of the frame. The device includes a first body support portion carried by the longitudinal support, the first body support portion configured to rotate about the longitudinal support relative to the longitudinal axis of the frame. The device includes a second body support portion carried by the longitudinal support, the second body support portion configured to rotate about the longitudinal support relative to the longitudinal axis of the frame.

### RELATED APPLICATIONS

This patent application claims the benefit of U.S. patent application Ser. No. 61/503,297 filed on Jun. 30, 2011, entitled, “TRAINING AND REHABILITATION DEVICE,” the contents and teachings of which are hereby incorporated by reference in their entirety.

### BACKGROUND

Conventional exercise and rehabilitation devices, such as exercise and/or rehabilitation tables, have a variety of uses. Certain exercise and rehabilitation tables focus their primary uses towards the physiological and/or kinesthetic rehabilitation of patients. Other types of exercise and rehabilitation tables pertain to chiropractic care, physical therapy and rehabilitation, massage therapy, holistic medicine, and other related exercise modalities. These tables come in a variety of shapes and sizes and can provide a broad spectrum of patient pain relief, or exercise performance enhancement.

### SUMMARY

A variety of conventional exercise and rehabilitation devices include moveable elements that can control the relative movement of certain portions of a user's body. However, none of the conventional devices have a set standard for the facilitation of human movements. For example, in the area of golf, none of the conventional exercise and rehabilitation table options are directed for implementation in the golf fitness industry. Additionally, none of the conventional exercise and rehabilitation table options are utilized for the development of a golf-specific training protocol to train a golfer to develop enhanced awareness of his hip, pelvic, and spinal alignment, or to provide quantification of such an alignment in a diagnostic setting, or application of use.

By contrast to conventional exercise and rehabilitation tables, embodiments of the innovation relate to a training and rehabilitation device. In one arrangement, the device is configured to develop and increase the efficiency of a user's movement within the transverse plane between the upper and lower portions of the user's body. For example, the device includes a thoracic body support portion, in one arrangement of use, and a lower body support portion pivotably coupled along a longitudinal axis of a frame of the device. The thoracic body support portion and lower body support portion are configured to pivot about the longitudinal axis independently from each other. In use, a user is placed onto the device, in either the supine or prone positions, with the user's thoracic body carried by the thoracic body support portion and the user's lower body carried by the lower body support portion. The corresponding first and second body support portions are allowed to independently rotate about the longitudinal axis while the user is required to maintain his upper and lower body portions in a neutral position. As a result of the user maintaining the relative positioning of his upper and lower body portions, over time, the user can experience an increase in muscle strength, as well as an increase in balance and proprioception. With particular reference to the golf industry, the device can help to train a golfer to develop enhanced awareness of his hip, pelvic, and spinal alignment to improve his golf swing and/or reduce the risk for musculoskeletal injury.

In one arrangement, the device is configured with a control system, such as a positional feedback mechanism or a digital interface, to provide the user with real-time positional feedback to help the user attain a desired state of physiological equilibrium.

In one arrangement, a device includes a frame having a longitudinal support extending along a longitudinal axis of the frame. The device includes a first body support portion carried by the longitudinal support, the first body support portion configured to rotate about the longitudinal support relative to the longitudinal axis of the frame. The device includes a second body support portion carried by the longitudinal support, the second body support portion configured to rotate about the longitudinal support relative to the longitudinal axis of the frame.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a perspective view of a device, according to one arrangement.

FIG. 2 illustrates a side view of the device of FIG. 1.

FIG. 3 illustrates a first body support portion of the device of FIG. 1 according to one arrangement.

FIG. 4 illustrates the rotational stop of the first support portion of FIG. 1.

FIG. 5 illustrates the rotational stop of FIG. 4 disposed in proximity to the first support portion of FIG. 1.

FIG. 6 illustrates a second body support portion of the device of FIG. 1 according to one arrangement.

FIG. 7 illustrates a rotational stop disposed in a first position relative to the second body support portion of FIG. 1.

FIG. 8 illustrates a rotational stop disposed in a second position relative to the second body support portion of FIG. 1.

FIG. 9 illustrates the first body support portion and the second body support portion rotating relative to a frame of the device independently from each other.

FIG. 10 illustrates a second body support portion of the device of FIG. 1 having a foot position adjustment mechanism disposed in a first position.

FIG. 11 illustrates a second body support portion of the device of FIG. 10 having the foot position adjustment mechanism disposed in a second position.

FIG. 12 illustrates the first body support portion rotated about a saggital axis of the frame of FIG. 1.

FIG. 13 illustrates an arrangement of a control system of the device of FIG. 1.

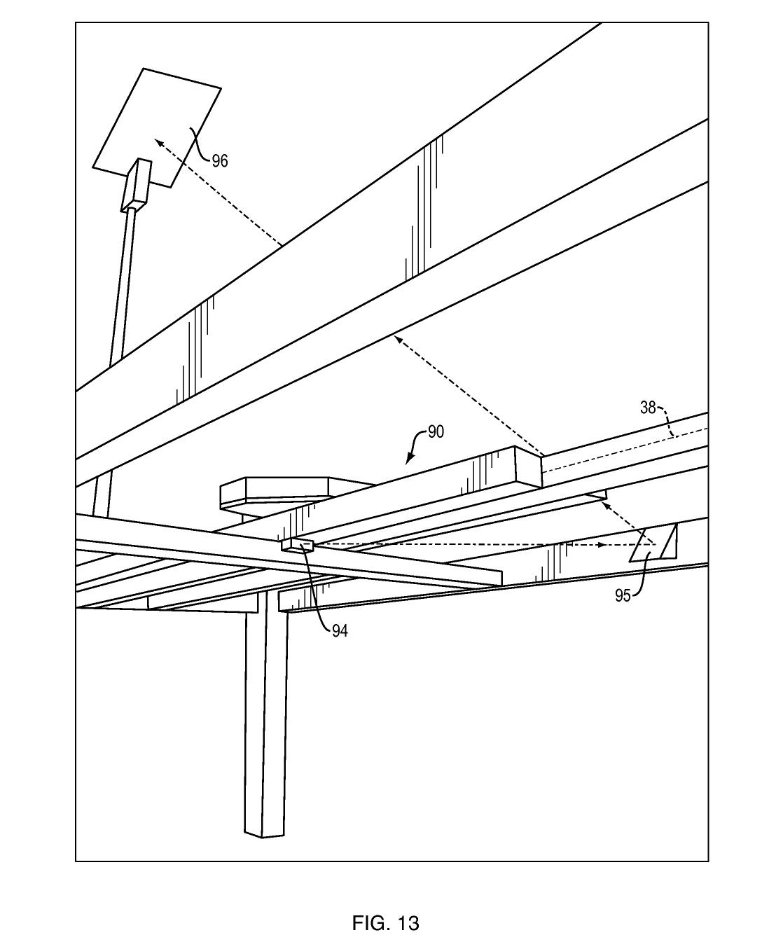

FIG. 14 illustrates an aerial view of a device, according to an alternate arrangement.

FIG. 15 illustrates a profile view of the device of FIG. 14 along a first longitudinal side.

FIG. 16 illustrates a transverse profile view of the device of FIG. 14 along a second side, the second side substantially perpendicular to the first side.

FIG. 17 illustrates a perspective view of the device of FIG. 14.

### DETAILED DESCRIPTION

Embodiments of the present device are configured to quantify musculoskeletal imbalances and rehabilitate, or re-train, any dysfunctional human movement pattern. The device can be utilized in the diagnostic field of sports medicine.

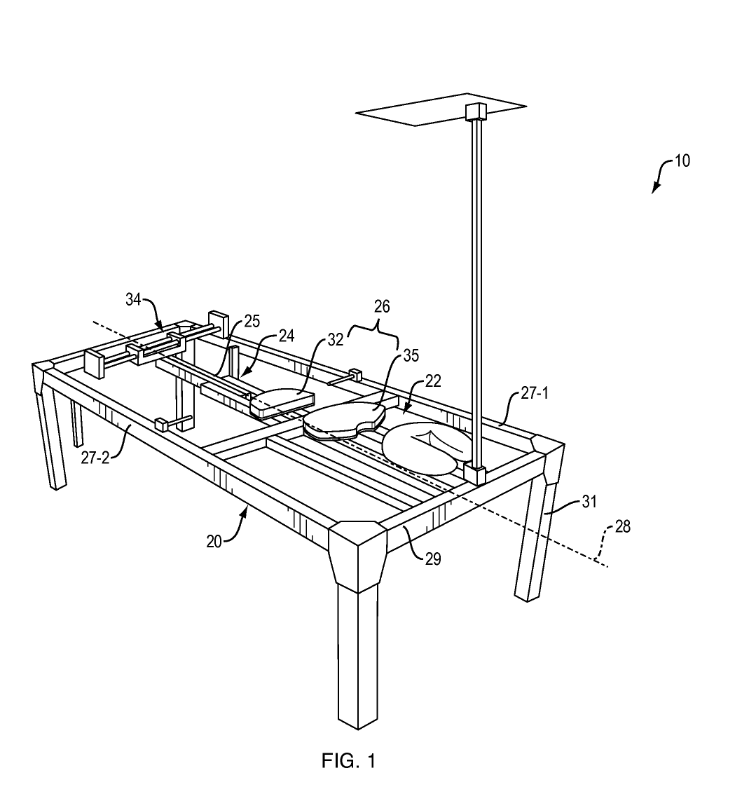

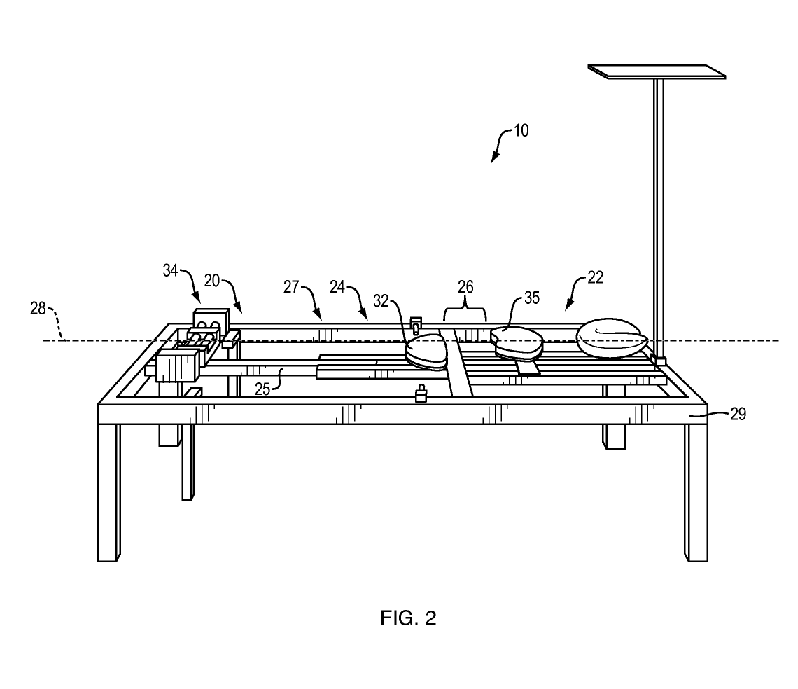

FIGS. 1 and 2 illustrates an example device 10 having a frame 20, a first body support portion 22 carried by the frame 20, and a second body support portion 24 carried by a longitudinal support 25 of the frame 20. While the frame 20 can be configured in a variety of ways, in one arrangement, the frame 20 includes a pair of side elements 27-1, 27-2 (collectively 27), a pair of saggital elements 29, and a set of support elements or legs 31 that maintain the side and saggital elements 27, 29 at a distance from the floor. The longitudinal support 25 extends along a longitudinal axis 28 of the frame 20 and is coupled to the side and saggital elements 27, 29 at a location approximately halfway between the saggital elements 27, 29.

The body support portions 22, 24 are sized and shaped to support particular portions of a human body. For example, the first body support portion 22 is configured to support a thoracic portion of a user's body and can include a thoracic support 35 and a head support 30. In another example the second support portion 24 is configured to support a lower body portion of a user's body and can include a pelvic support 32 and a foot support 34. Details of the body support portions 22, 24 are provided below.

The first and second body support portions 22, 24 are rotatably coupled to the frame 20 via the longitudinal support 25. The longitudinal support 25 is independently connected to the first and second body support portions 22, 24, respectively, via fixed, mounted bearings and two opposing bolts (e.g., one at the top of each portion 22, 24 and one at the bottom of each portion 22, 24), to ensure that each portion 22, 24 rotates about the fixed longitudinal support 25.

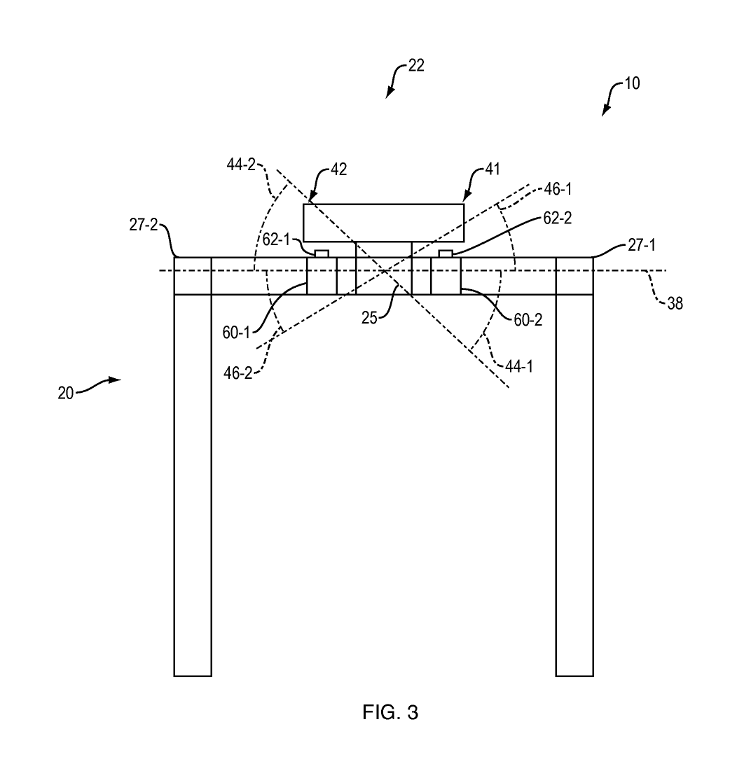

With reference to FIG. 3, the first body support portion 22 is configured to rotate about the longitudinal axis 28 within a physiological range associated with a user's upper body (i.e., above the user's thoracic spine (T10)), such as between about +10° and −10° relative to a neutral plane 38 defined by the side and saggital elements 27, 29 of the frame 20. For example, as a first side 41 of the first body support portion 22 rotates through a first angle 44-1, +10°, relative to the plane 38, a second side 42 of the first body support portion 22 rotates through a corresponding first angle 44-2, +10°, relative to the plane 38. Additionally, as the second side 42 of the first body support portion 22 rotates through a second angle 46-1, −10°, relative to the plane 38, the second side 42 of the first body support portion 22 rotates through a corresponding second angle 46-2, −10°, relative to the plane 38.

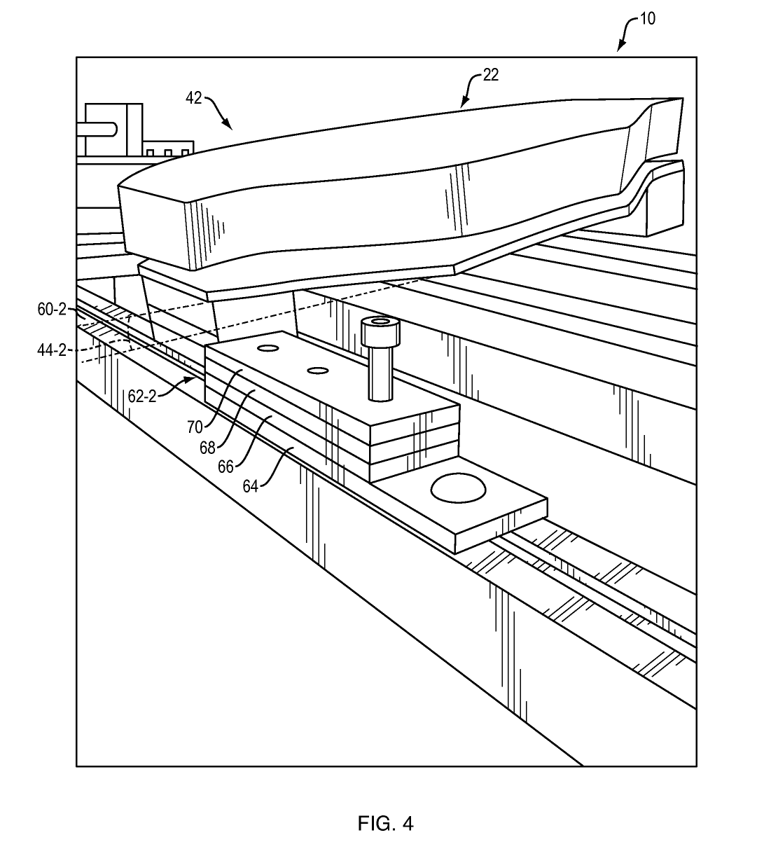

In one arrangement, the device 10 is configured to set the rotation of the first body support portion 22 to between about +10° and −10°. For example, with reference to FIG. 3, the device 10 includes a first body support portion rotational stop 60 configured to limit rotation of the first body support portion 22 about the longitudinal support 25 to between about −10° and 10° relative to the plane 38. In one arrangement, the stop 60 includes a first stop portion 60-1 that opposes the first side 41 of the first body support portion 22 and a second stop portion 60-2 that opposes the second side 42 of the first body support portion 22. In the example indicated in FIG. 4, as the first body support portion 22 rotates toward the side element 27-2, the second body support portion rotational stop 60-2 limits the rotation of the support portion 22 to an angle 44-2 of −10° relative to the horizontal plane 38. It should be noted that, while not shown, as the first body support portion 22 rotates toward the side element 27-1, the first body support portion rotational stop 60-1 limits the rotation of the support portion 22 to an angle 44-2 of −10° relative to the horizontal plane 38.

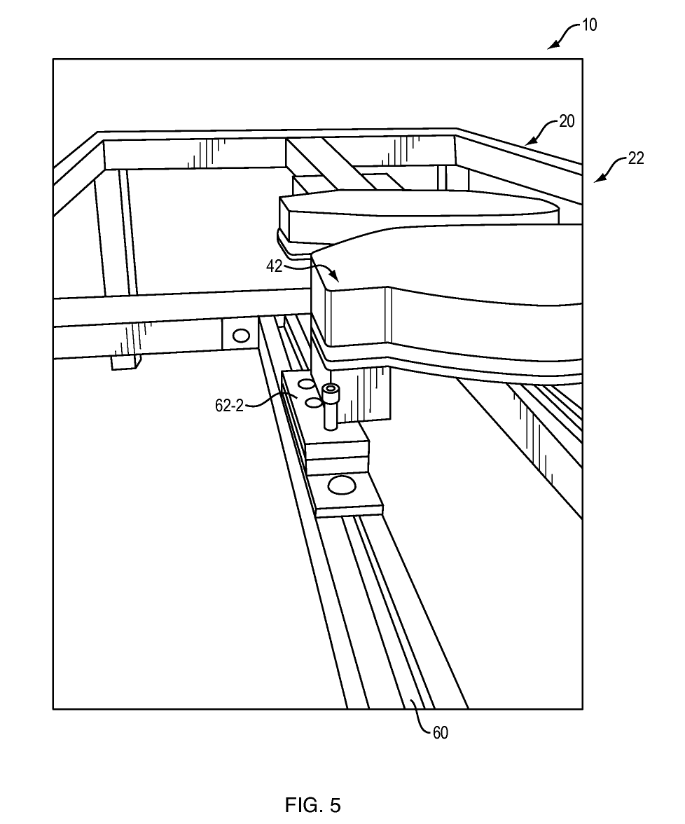

In one arrangement, the first body support portion rotational stop 60 is configured to adjust the degree to which the first body support portion 22 rotates relative to the horizontal plane 38. For example, with reference to FIGS. 3-5, the stop 60 includes a first set of locking blocks 62-1 coupled to the first stop portion 60-1 and a second set of locking blocks 62-2 coupled to the second stop portion 60-2. Taking the second set of locking blocks 62-2 of FIGS. 4 and 5 as an example, the second set of locking blocks 62-2 include individual bock elements 64, 66, 68, 70 which create a shim between the second side 42 of the first body support portion 22 and the second stop portion 60-2. When an operator disposes all four block elements 64, 66, 68, and 70 between the second side 42 of the first body support portion 22 and the second stop portion 60-2, as indicated in FIG. 5, the block elements 64, 66, 68, and 70 lock the position of the first body support portion 22 to the frame 20 to minimize rotation of the first body support portion 22. Alternately, the operator can selectively dispose the first block element 64, the first and second block elements 64, 66, or the first, second, and third block elements 64, 66, 68 to limit the rotation of the first body support portion 22 to either −7.5°, −5°, or −2.5°, respectively, relative to the horizontal plane 38.

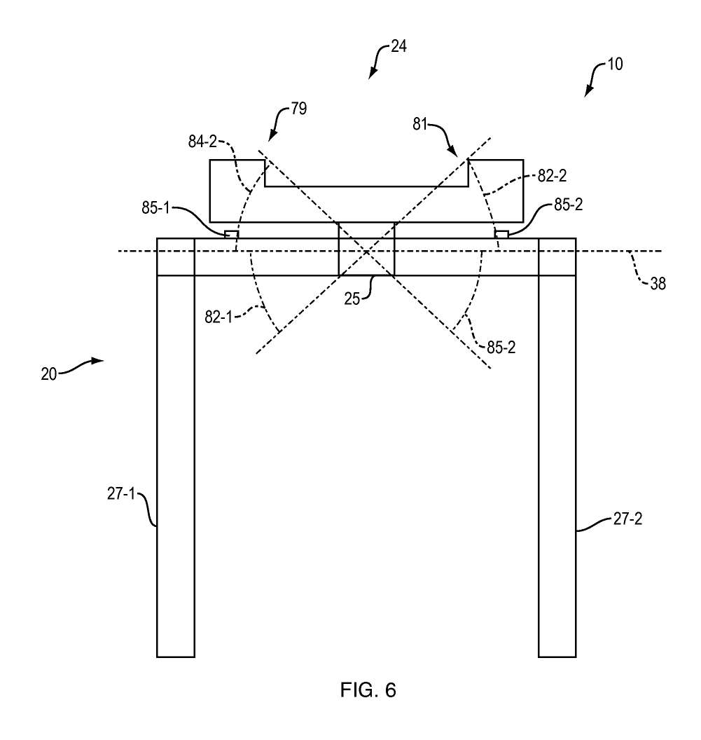

With reference to FIG. 6, the second support portion 24 is configured to rotate about the longitudinal axis 28 within a physiological range associated with a user's lower body (i.e., below the user's sacroiliac joint) such as between about +45° and −45° relative to the lateral or neutral plane 28. For example, as a first side 79 of the second body support portion 24 rotates through a first angle 82-1, +45°, relative to the plane 38, a second side 81 of the second body support portion 24 rotates through a corresponding first angle 82-2, +45°, relative to the plane 38. Additionally, as the second side 81 of the second body support portion 24 rotates through a second angle 84-1, −45°, relative to the plane 38, the second side 42 of the first body support portion 22 rotates through a corresponding second angle 84-2, −45°, relative to the plane 38.

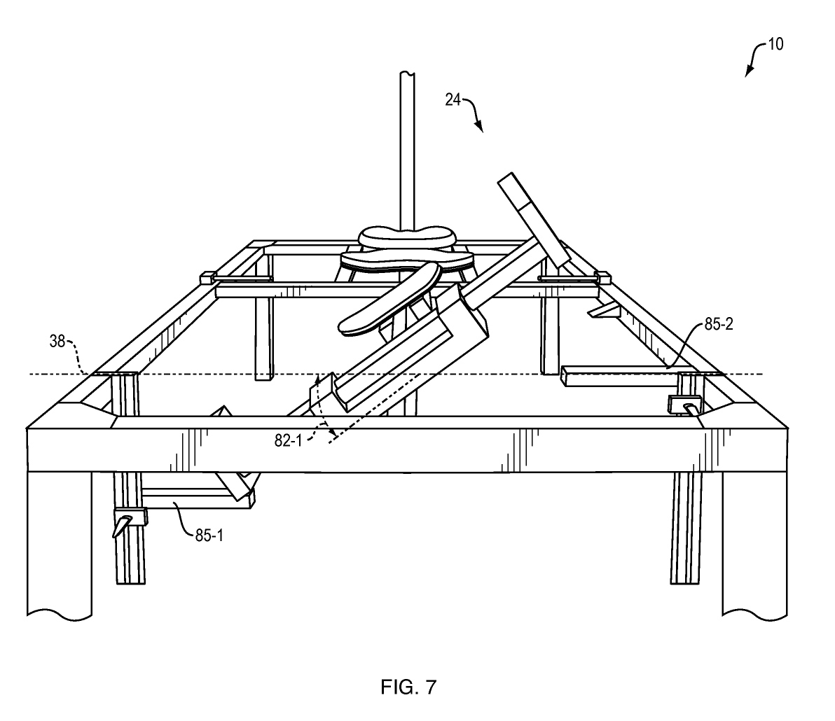

In one arrangement, the device 10 is configured to set the rotation of the second body support portion 24 to between about +45° and −45°. For example, with reference to FIG. 6, the device 10 includes a second body support portion rotational stop 85 configured to limit rotation of the second body support portion 24 about the longitudinal support 25 to between about −45° and +45° relative to the plane 38. In one arrangement, the stop 85 includes a first stop portion 85-1 that opposes the first side 79 of the second body support portion 24 and a second stop portion 85-2 that opposes the second side 81 of the second body support portion 24. In the example indicated in FIG. 7, as the first body support portion 22 rotates toward the side element 27-1, the second body support portion rotational stop 85-1 limits the rotation of the support portion 24 to an angle 44-2 of +45° relative to the horizontal plane 38.

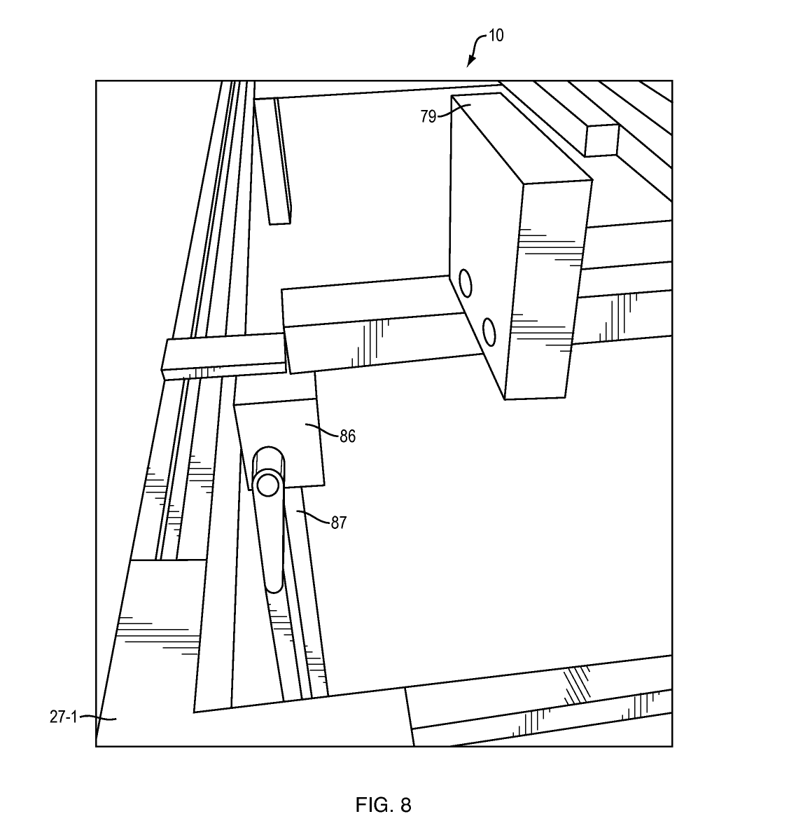

In one arrangement, the second body support portion rotational stop 85 is configured to adjust the degree to which the second body support portion 24 rotates relative to the plane 38. For example, with reference to FIG. 8, and taking stop 85-1 as an example, the stop 85-1 includes a block 86 moveably disposed on a support 87 carried by the frame 20. An operator laterally positions the block 86 along the support 87 to set a minimum or maximum angle of rotation for the second body support portion 24. As illustrated in FIG. 8, the operator disposes the block 86 on the support 87 in proximity to the end 79 of the support portion 24 to lock the position of the second body support portion 24 to the frame 20, thereby minimizing rotation of the end 79 of second body support portion 24 along angle 82-1. As illustrated in FIG. 7, the operator disposes the block 86 on the support 87 at a distance from the end 79 of the support portion 24 to allow rotation of the end 79 of second body support portion 24 along angle 82-1.

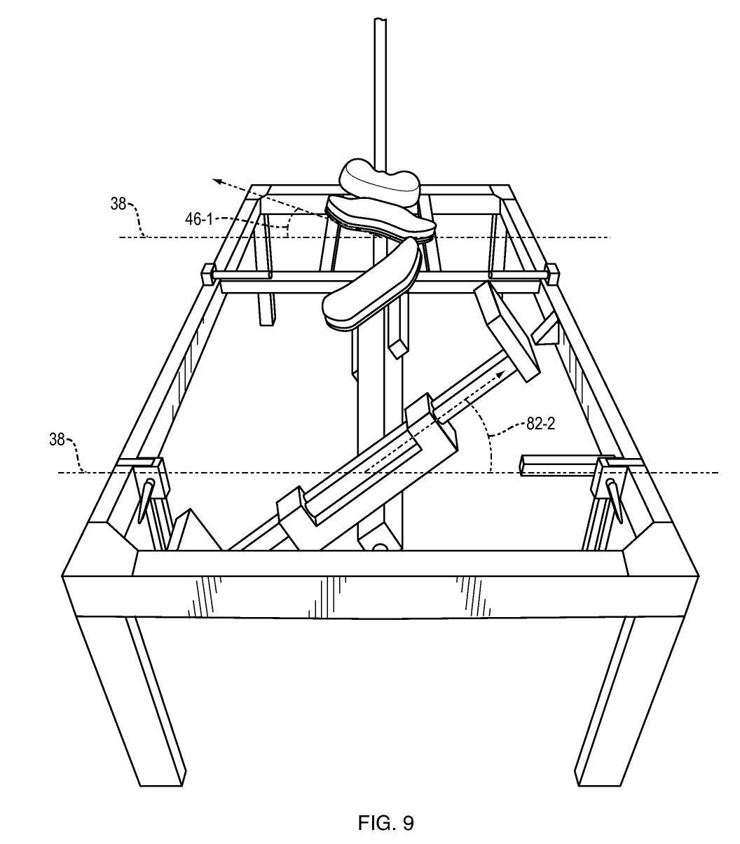

In one arrangement, the first and second body support portions 22, 24 are configured to rotate about the longitudinal support 25 independently from each other and relative to the longitudinal axis 28 of the frame 20. For example, as illustrated in FIG. 9, the first body support portion 22 rotates about −10° through angle 46-1 while the second body support portion 24 rotates about +45° through angle 82-2. During operation, the independent rotation of the first and second body support portions 22, 24 maximizes a user's muscle responsiveness in maintaining body alignment, such as within the horizontal plane 38.

Returning to FIGS. 1 and 2, the first and second body support portions 22, 24, define a separation space 26 there between. Physiologically, as a user rotates his/her body, rotation takes place below the user's sacroiliac joint and above the user's lumbar (L1) spine. Accordingly, the separation space 26 between the first and second support portions 22, 24 disengages static support to the user above his sacroiliac joint (i.e., at the top portion of the second body support portion 24), and re-engage static support to the user beginning approximately at the user's thoracic spine (T10) (i.e., at the bottom of the first body support portion 22) and above, including support to both scapular bones, the cervical spine, and head. With such disengagement of static support, the device 10 allows the user to rotate his upper body and lower body in a physiologically appropriate, and functionally safe, manner while minimizing or preventing rotation of the user's lumbar spine. This rotation allows the user to gain an enhanced proprioception of proper movements associated with his body.

In use, with the first and second body support portions 22, 24 locked to the frame to minimize rotation, a user is placed onto the device 10 in either the supine or prone positions, as decided by an operator. For example, the operator places the user's upper body on the first body support portion 22 and the operator places the user's lower body on the second body support portion 24. The operator can then release the first and second body support portions 22, 24 from the frame 20 to allow the portions 22, 24 to rotate about the longitudinal axis 28 of the device 10. Here, the operator can direct the user to execute a variety of active and passive skeletal joint movements which may be resisted or un-resisted, depending on the operator's objective for that particular user during a session. For example, the user can be required to maintain his upper and lower body portions in a neutral position the horizontal plane 38 while the corresponding first and second body support portions 22, 24 are allowed to independently rotate about the longitudinal axis. In another example, such as with a golfer, the golfer can utilize the device to rotate his first body portion relative to his second body potion to gain proprioception of proper body alignment for a golf swing. Accordingly, the device 10 can maximize a user's muscle response in performing particular body alignment exercises and can allow the user to gain a proprioception of proper movements associated with his body

In one arrangement, prior to positioning a user on the device 10, an operator can adjust the position of the components of the device 10 to accommodate a variety of user-specific physiologies.

For example, the thoracic support 35 of the first body support portion 22 and the pelvic support 32 of the second body support portion are configured to translate along the longitudinal support 25 and to be secured to the support 25 to accommodate a variety of different user heights. As indicated above, the separation space 26 between the thoracic support 35 and the pelvic support 32 disengages static support above the sacroiliac joint and re-engages static support beginning approximately at the user's thoracic spine (T10). However, the length of the separation space 26 can vary from user to user, depending upon the user's height. Accordingly, the thoracic support 35 can include a securing mechanism (not shown) that releaseably secures the thoracic support 35 to the longitudinal support 25 and allows the operator to adjust the position of the thoracic support 35 along the longitudinal support 25 and relative to the user's thoracic spine. Additionally, the pelvic support 32 can include a securing mechanism (not shown) that releaseably secures the pelvic support 32 to the longitudinal support 25 and allows the operator to adjust the position of the pelvic support 32 along the longitudinal support 25 and relative to the user's sacroiliac joint.

In another example, the head support 30 is configured to translate along the longitudinal support 25 and to be secured to the support 25 to accommodate a variety of different user heights. In one arrangement, the head support 30 can include a securing mechanism (not shown) that releaseably secures the head support 30 to the longitudinal support 25 and allows the operator to adjust the position of the head support 30 relative to the thoracic support 35 based upon the user's height.

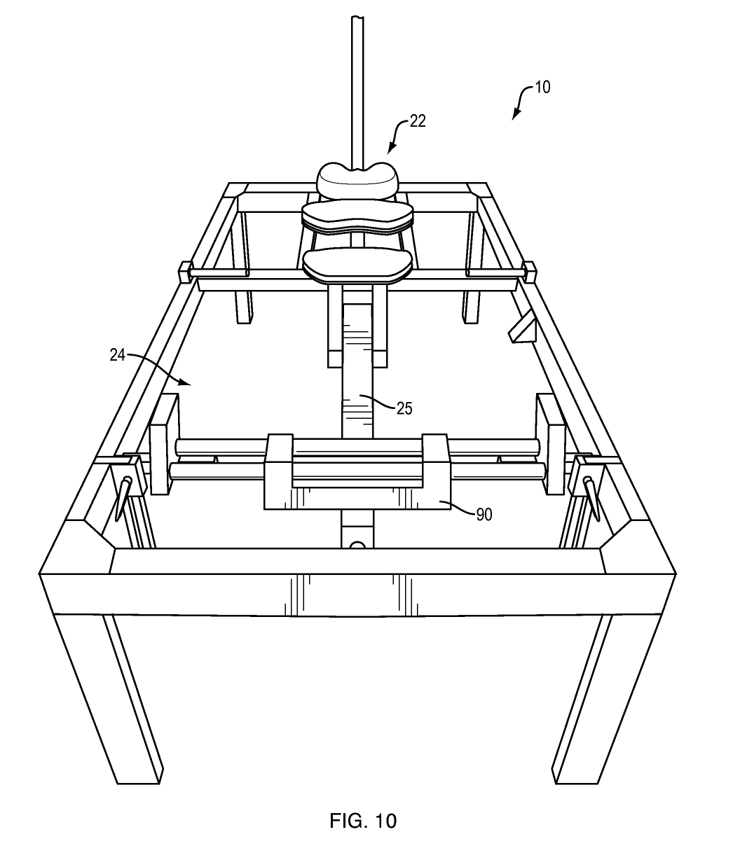

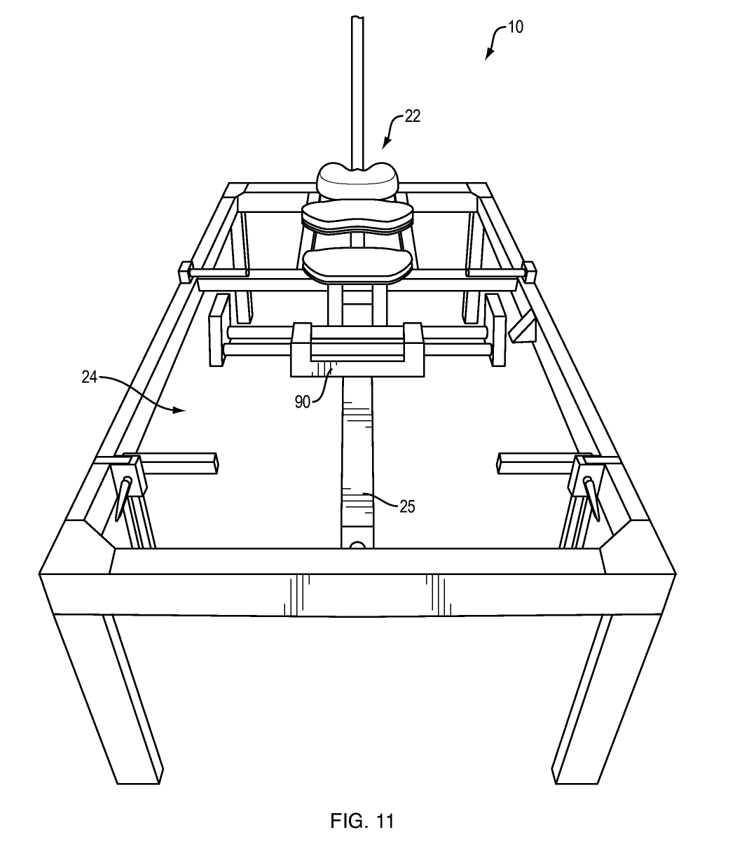

In another arrangement, with reference to FIGS. 10 and 11, the second body support portion includes a foot support portion 90 carried by the longitudinal support 25. The foot support portion 90 is configured to translate along the longitudinal support 25 and to be secured to the support 25 to position a user's legs in an extended position, as indicated in FIG. 10, or in a retracted position, as indicated in FIG. 11, relative to the first body support portion 22. Positioning of the user's lower body in a retracted position can relieve stress from the user's lumbar spine during operation.

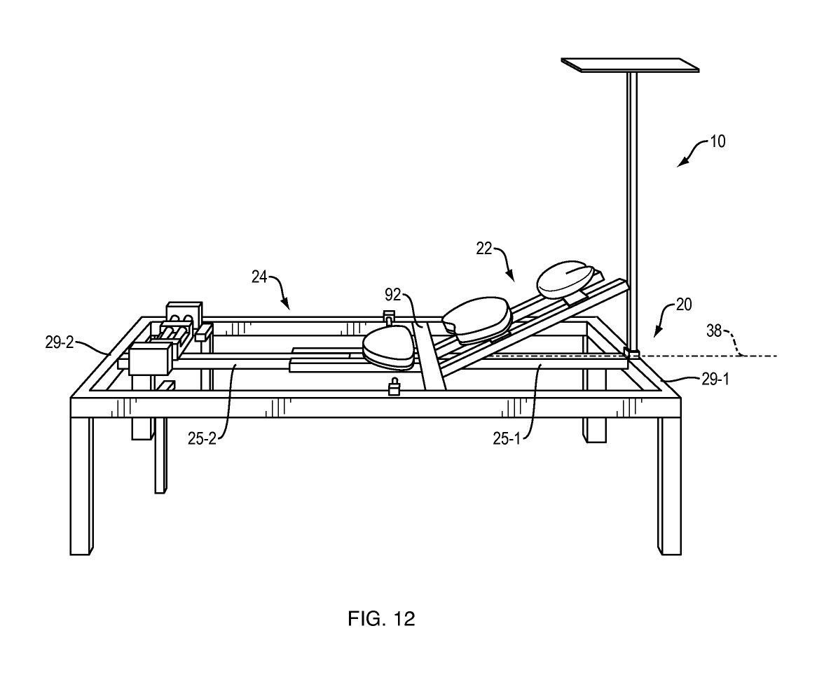

In one arrangement, the device 10 is configured to place a user's thoracic body in a flexed or extended position relative to the user's lower body. For example, with reference to FIG. 12, the longitudinal support 25 includes a first longitudinal support portion 25-1 that couples the first body support portion 22 to the frame 20 between a first saggital element 29-1 and a lateral axis 92. The longitudinal support 25 also includes a second longitudinal support portion 25-2 that couples the second body support portion 24 to the frame 20 between a second saggital element 29-2 and the lateral axis 92. As illustrated, the first body support portion 22 is configured to rotate about the lateral axis relative to the second longitudinal support portion 25-2 and the second body support portion 24. For example, the thoracic body support 35 is rotatably attached to the second longitudinal support portion 25-2 to allow for rotation of the user's thoracic spine in the transverse plane. While the first body support portion 22 can be disposed at a variety of angles relative to relative to the horizontal plane 38, in one arrangement, the first body support portion 22 is configured to rotate about the lateral axis 92 between about −15° and 15° relative to the plane 38.

The device 10 can also be configured with a control system 40 to provide the user with real-time positional or biofeedback relative to his position (e.g., his neutral position) within the device 10. With reference to FIG. 1, in one arrangement, the control system 40 is configured as a laser or light source 94 which is mounted to one or both of the upper and lower body support portions 22, 24. During operation, the light source 94 generates a light beam that is reflected onto a free-standing target 96, via a mirrored surface 95, which the user will be able to see. Alignment of the light beam, generated by the light source 94, with the target 96 represents a true level or neutral position of the user's upper and lower body relative to the plane 38. By adjusting his upper and lower body balance on the upper and lower body support portions 22, 24 of the device 10, the user can maneuver the light beams to align with the corresponding targets to attain a desired body position.

In one arrangement, the control system 40 is configured as a computer having a controller (e.g., a memory and a processor) as well as one or more sensors disposed in electrical communication with the computer, such as via a wireless (e.g., Bluetooth) communication protocol. For example, the sensors can be configured as one or more accelerometers, inclinometers, gyroscopes, and/or tilt sensors. The sensors can be carried by the device 10 at multiple, specified locations to quantify any of the acute variables deemed relevant by the operator for the purposes of a given training session. For example, one or more of the sensors can be carried by one of, or both, the upper and lower body support portions 22, 24 of the device 10. The sensors are configured to provide spatial positioning data to the computer which, in turn, is configured to display the data to the user as biofeedback via a display. In one arrangement, the control system is configured to store the positioning data for analysis at a later time. For example, the respective data can be analyzed by the operator, and then presented to the user through a customized software program and graphical user interface imagery, such as in frame-by-frame post-motion.

In one arrangement, the resistance of the first and second body support portions 22, 24 can be adjusted. For example, free-weights may be mounted, or hung, from specified locations on the upper and lower body support portions 22, 24. Using a free-weight would take into account a support portion's gravitational force vector, meaning its actual resistance would change as its moment arm angle becomes either more or less obtuse or acute. In another example, resistance or elastic tubing can be attached to the upper and lower body support portions 22, 24 at specified locations. Using a resistance tube would take into account the increasing resistance profile of the upper and lower body support portions 22, 24 as any range of motion is increased towards its maximum allowable capacity (movements are measured in degrees or radians).

In another example, mechanized resistance mechanisms such spools can be attached to either of the pivot axes 28, 36, and a computer-regulated motor may apply torque against a certain movement. This would corrupt the skeletal alignment of the user, and cause him/her to engage the proper muscles to retain a desired state (i.e., a neutral position). Specific muscles would work in conjunction with the direction that the resistance was to be actuated.

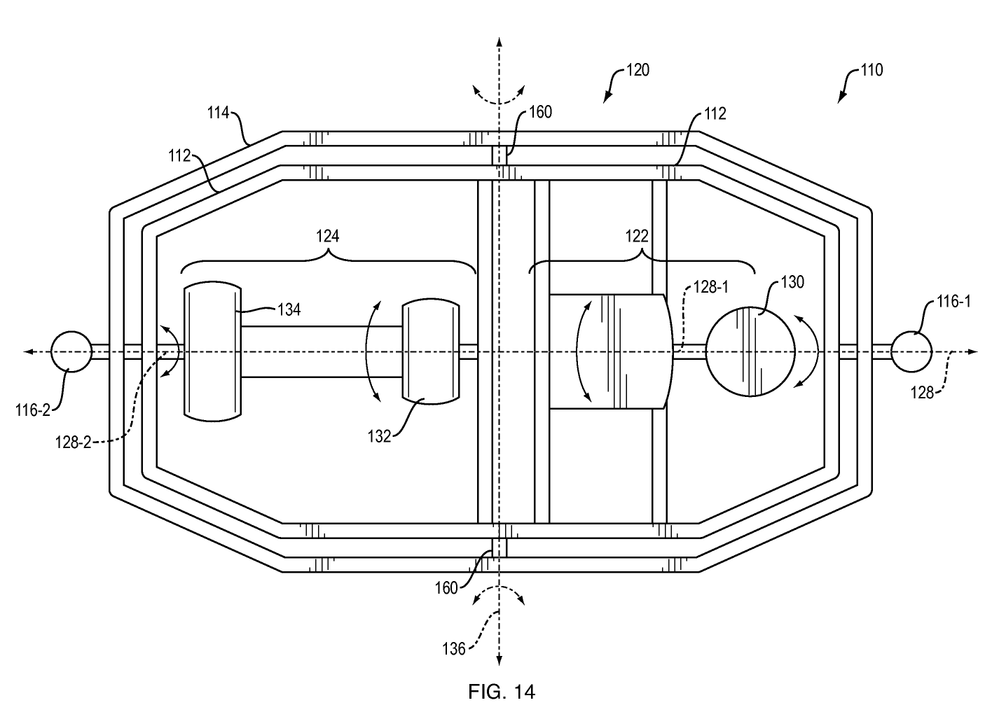

FIGS. 14-17 illustrate another arrangement of the device 110 where the device 110 includes a frame 120 having two horizontal table frames, such as a first or inner frame 112 and a second or outer frame 114 which sit one inside of the other, as well as supports 116-1, 116-2.

The device 110 supports the user upon two axes: an upper body axis 128-1 and a lower body axis 128-2. For example, the inner frame 112 includes first and second body support portions 122, 124, each disposed on a corresponding first and second axis of rotation 128-1, 128-2. While these two axes exist along the same longitudinal axis 128 (vertical axis), they are mechanized either as independent, co-dependent, or inter-dependent, allowing a maximal separation range of about 45 degrees in either direction, clockwise or counter-clockwise. For example, the upper body support portion 122 includes a stop portion that limits rotational movement to between about +/−8 degrees from a neutral position in either direction, providing a total range of potential movement of about 16 degrees. Additionally, the lower body support portion 124 includes a stop portion that limits rotational movement to between about +/−35 degrees of rotational movement from a neutral position in either direction, providing a total range of potential movement of about 70 degrees. In one arrangement, the limited ranges of motion that are applied to the use of the device 110 are implemented as safety protocol to minimize or prevent a circumstance where a user becomes injured due to hyper-rotation (i.e., rotating further than designed) in the transverse plane.

Either of the two axes 128-1, 128-2 may be set into a number of combinations of user-relevant applications. For example, the two axes 128-1, 128-2 can be set in a fixed position within the parameters of their available range of motion, in a non-resisted motion within the entire range of motion; in a non-resisted motion within a set range of motion; in a resisted motion within the entire range of motion; and in a resisted motion within a set range of motion.

The available range of motion of the upper body axis 128-1 is between about 8 degrees in either clockwise or counter-clockwise directions, for a total range of motion of about 16 degrees in the transverse plane. The available range of motion of the lower body axis 128-2 is between about 35 degrees in either clockwise or counter-clockwise directions, for a total range of motion of about 70 degrees in the transverse plane.

As indicated above, the frame 120 includes a first or inner frame 112 and a second or outer frame 114.

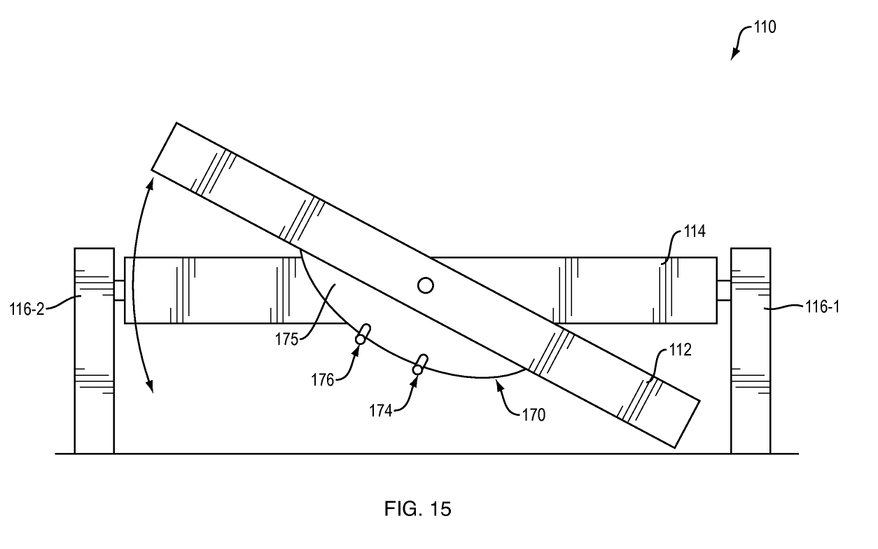

The inner frame 112 houses the user and is configured as a gimbal. The inner frame 112 is rotatably secured to the outer frame 114 at a midline of a longitudinal side of the frame 120 via securing mechanisms 160. Thus, the inner frame 112 allows a user to rotate in the saggital plane (forward and backward movement) as indicated in FIG. 15. From a neutral and level position, this inner frame 112 can rotate between about +/−15 degrees relative to the neutral position, thereby allowing for a total range of saggital plane movement of about 30 degrees. This range may be limited, unlimited, resisted, or non-resisted, or any combination therein. This movement may be held static anywhere within that range as well.

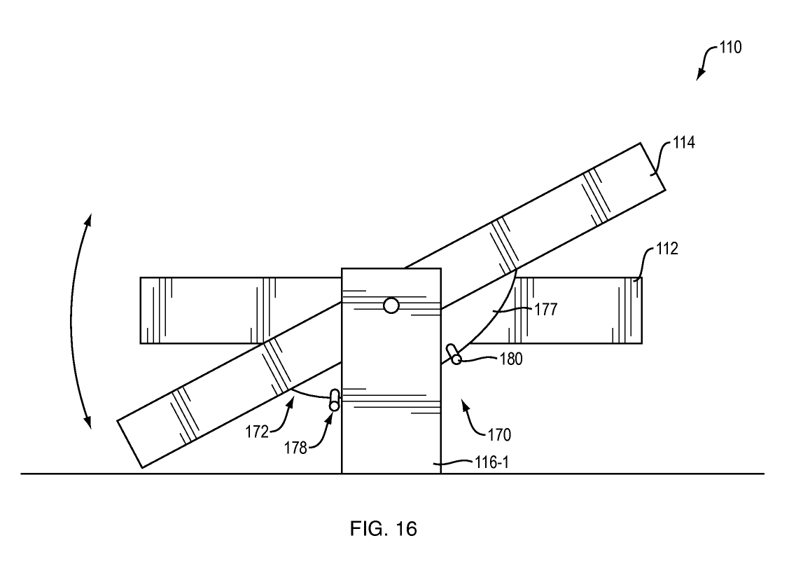

The outer frame 114 connects to the inner frame 112 along the longitudinal side at the midline via securing mechanisms 160. The outer frame 114 also connects to the supports 116-1, 116-2, which are located at the head and feet of the user at the midline of the short side of the device 110. Thus the outer frame 114 allows a user to move in the transverse plane (rotational movement), as indicated in FIG. 16. From a neutral and level position, the outer frame 114 can rotate between about +/−15 degrees from the neutral position (i.e., clockwise or counter-clockwise) for a total range of transverse plane movement of about 30 degrees. This range may be limited, unlimited, resisted, or non-resisted, or any combination therein. This movement may be held static anywhere within that range as well.

Each of the inner and outer frame 112, 114 is equipped with a stop portion 170, 172, respectively, that operate as a safety mechanism to minimize or prevent over rotation of the frames 112, 114. For example, as shown in FIG. 14, the inner frame 112 includes the stop portion 170 having a half-moon shaped support 175 that carries a set of stops 174, 176 extending from the support 175 at an appropriate length to allow for between about +/−15 degrees of movement in each direction from a neutral position. In another example, as shown in FIG. 15, the outer frame 114 includes the stop portion 172 having a half-moon shaped support 177 that carries a set of stops 178, 180 extending from the support 177 at an appropriate length to allow for between about +/−15 degrees of movement in each direction from a neutral position

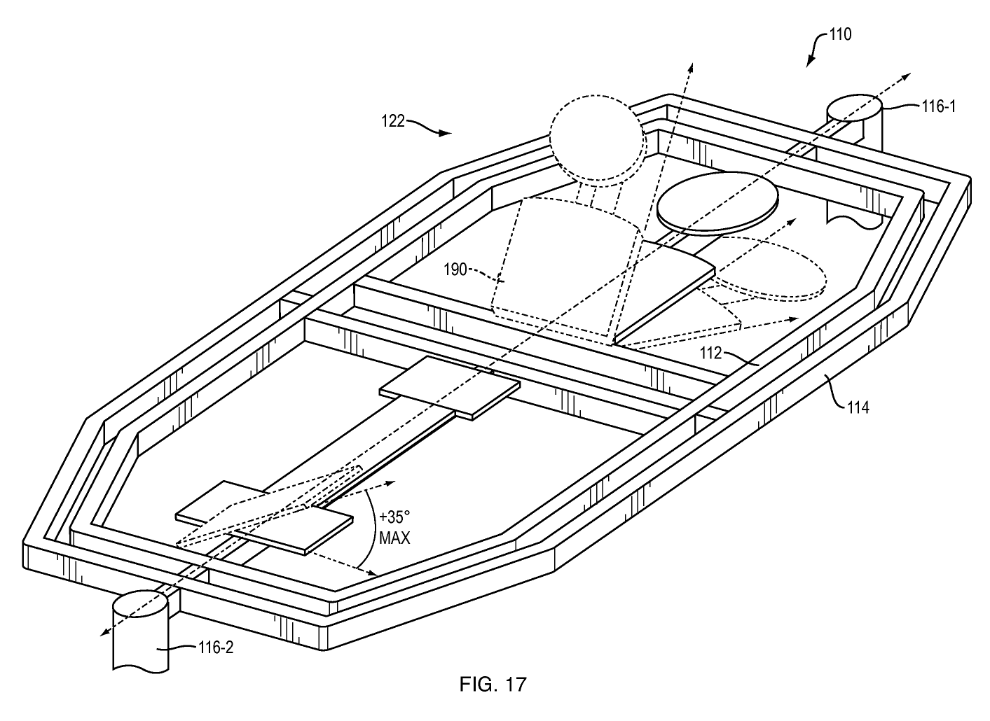

As illustrated in FIG. 17, the upper body support portion 122 within the inner frame 112 is designed to fully support and articulate a human's physiology from an upright, seated position, down to the supine position, and can be actuated by a robotic control mechanism. For example, the upper body support portion 122 includes a supported and mechanized backrest 190 which can incline from a neutral position to about 70 degrees, and decline from a neutral position to about 15 degrees, providing a total range of potential movement of about 85 degrees.

In use the user lies upon the body support pieces 122, 125 within the table's inner frame 112. The inner frame 112 and the user are attached to a symmetrically optional third plane of movement via the outer frame 114. The connection of how each of the pieces move (the user, the inner frame 112, and the outer frame 114) are suggestive, yet limited movements most closely noted by a gyroscopic style of movement.

While various embodiments of the innovation have been particularly shown and described, it will be understood by those skilled in the art that various changes in form and details may be made therein without departing from the spirit and scope of the innovation as defined by the appended claims.

Terminology such as equilibrium, neutral, true neutral, or level, have been used to describe the state of a human body such that when placed in either the supine or prone position, the transverse, or rotational segments that separate the upper and lower body are properly aligned both to one another as well as to gravity's pull.

As indicated above, the device 10 includes a control system 40. In one arrangement, the device 110 also includes a control system 40 as described above to provide the user with biometric feedback information.

All mobile (e.g., rotatable) pieces of the devices 10, 110, individually or as a group, may be held static, in any position, based upon a session's demands.

What is claimed is:

1. A device, comprising:
a frame having a longitudinal support extending along a longitudinal axis of the frame;
a first body support portion carried by the longitudinal support, the first body support portion configured to rotate about the longitudinal support relative to the longitudinal axis of the frame; and
a second body support portion carried by the longitudinal support, the second body support portion configured to rotate about the longitudinal support relative to the longitudinal axis of the frame.

2. The device of claim 1, wherein:
the first body support portion is configured to support a thoracic portion of a user body; and
the second support portion is configured to support a lower body portion of a user body.

3. The device of claim 2, wherein the first body support portion and the second body support portion define a separation space there between, the separation space configured to disengage static support of at least a portion of a user disposed between the first support portion and the second support portion.

4. The device of claim 3, wherein the first body support portion comprises a thoracic support portion configured to translate along the longitudinal axis of the longitudinal support and relative to the second support portion to define the separation space.

5. The device of claim 3, wherein the second support portion comprises pelvic support portion configured to translate along the longitudinal axis of the longitudinal support and relative to the first support portion to define the separation space.

6. The device of claim 2 wherein the second support portion further comprises a foot support portion carried by the longitudinal support.

7. The device of claim 6, wherein the foot support portion is configured to be disposed between an extended position relative to the first body support portion and a retracted position relative to the first body support portion along the longitudinal axis of the longitudinal support.

8. The device of claim 1, comprising a first body support portion rotational stop, the first body support portion rotational stop configured to limit rotation of the first body support portion about the longitudinal support to between about −10° and 10° relative to a lateral plane defined by the frame.

9. The device of claim 1, comprising a second body support portion rotational stop, the second body support portion rotational stop configured to limit rotation of the second body support portion about the longitudinal support to between about −45° and 45° relative to a lateral plane defined by the frame.

10. The device of claim 1, wherein the longitudinal support comprises a first longitudinal support portion configured to carry the first body support portion and a second longitudinal support portion configured to carry the second body support portion, the first body support portion configured to rotate about a lateral axis defined by the frame and relative to the second longitudinal support portion and the second body support portion, the lateral axis being substantially perpendicular to the longitudinal axis.

11. The device of claim 10, wherein the first longitudinal support portion and the first body support portion are configured to rotate about the lateral axis between about −15° and 15° relative to a lateral plane defined by the frame.

12. The device of claim 1, further comprising a control system carried by at least one of the first body support portion and the second body support portion, the control system configured to generate positional feedback regarding a rotational position of the mechanism at least one of the first body support portion and the second body support portion relative to a lateral plane defined by the frame.

13. The device of claim 1, wherein the first body support portion comprises a head support portion carried by the longitudinal support.

14. The device of claim 13, wherein the head support portion is configured to translate along the longitudinal axis of the longitudinal support and relative to the first body support portion.

15. A device, comprising:
a frame having a first frame portion and a second frame portion, the first frame portion surrounding the second frame portion, the first frame portion rotatably coupled to a set of frame supports, the first frame portion configured to rotate about a longitudinal axis relative to the frame supports, and the second frame portion rotatably coupled to the first frame portion, the second frame portion configured to rotate about a saggital axis relative to the first frame portion;
a first body support portion carried by the second frame portion, the first body support portion configured to rotate about the longitudinal axis relative to the frame supports; and
a second body support portion carried by the second frame portion, the second body support portion configured to rotate about the longitudinal axis relative to the frame supports.

16. The device of claim 15, wherein:
the first body support portion is configured to support a thoracic portion of a user body; and
the second support portion is configured to support a lower body portion of a user body.

17. The device of claim 16, wherein the first body support portion and the second body support portion define a separation space there between, the separation space configured to disengage static support of at least a portion of a user disposed between the first support portion and the second support portion.
